(19) United States
(12) Patent Application Publication
(10) Pub. No.: US 2026/0276266 A1
(43) Pub. Date: Sep. 17, 2026

(54) INTEGRATED COOLING MODULE

(71) Applicant: Hanon Systems, Daejeon (KR)

(72) Inventors: Sangyong RHEE, Daejeon (KR); Hak Kyu KIM, Daejeon (KR); Byung Joo KIM, Daejeon (KR)

(73) Assignee: Hanon Systems, Daejeon (KR)

(21) Appl. No.: 19/168,273

(22) PCT Filed: Jun. 19, 2024
(86) PCT No.: PCT/KR2024/008425

§ 371 Date: Sep. 23, 2025

(30) Foreign Application Priority Data
Jun. 21, 2023 (KR) 10-2023-0079625

(51) Int. Cl. F25B 41/31; H01M 10/625; H01M 10/6568

(52) U.S. Cl. CPC F25B 41/31; H01M 10/625; H01M 10/6568; F25B 2339/043; F25B 2339/047; F25B 2500/01; F25B 2500/21; F25B 2500/32; F25B 2700/19; F25B 2700/21

(57) ABSTRACT

The present invention discloses an integrated cooling module in which heat exchange components are integrated into a single module by installing a heat exchanger and a valve in a central refrigerant manifold, and the valve is disposed opposite to the heat exchanger, thereby improving packaging efficiency and refrigerant flow characteristics.

### TECHNICAL FIELD

The present invention relates to an integrated cooling module applied to a vehicle cooling system, and more particularly, to an integrated cooling module in which heat exchange components are integrated into a single module by installing a heat exchanger and a valve in a central refrigerant manifold, and the valve is disposed opposite to the heat exchanger, thereby improving packaging efficiency and refrigerant flow characteristics.

### BACKGROUND ART

Recently, as there is gradually increasing interest in energy efficiency and problems of environmental pollution, there is a need for development of environmental-friendly vehicles that can substantially replace internal combustion engine vehicles. The environmental-friendly vehicles are typically classified into an electric vehicle which operates by using fuel cells or electricity as a power source, and a hybrid vehicle that operates by using an engine and a battery.

Unlike an air conditioning device for a general vehicle, a separate heater is not used for an electric vehicle or a hybrid vehicle among the environmental-friendly vehicles. The air conditioning system applied to the environmental-friendly vehicle typically refers to a heat pump system.

Meanwhile, the electric vehicle generates driving power by converting energy, which is generated by a chemical reaction between oxygen and hydrogen, into electrical energy. In this process, because thermal energy is generated by a chemical reaction in a fuel cell, it is essential to effectively remove generated heat to ensure performance of the fuel cell.

Further, the hybrid vehicle also generates driving power by operating an engine that uses general fuel to operate and operating a motor by using electric power supplied from the fuel cell or an electric battery. Therefore, to ensure performance of the motor, it is necessary to effectively remove heat generated from the fuel cell or battery and the motor.

Therefore, in the hybrid vehicle or the electric vehicle in the related art, a battery cooling system needs to be configured as a separate closed circuit, together with a cooling system and a heat pump system, in order to prevent heat generation by the motor, the electrical components, the fuel cell, and the battery.

For this reason, there are problems in that a size and weight of a cooling module disposed at a front side of a vehicle are increased, and layouts of connection pipes for supplying a refrigerant or coolant to a heat pump system, a cooling means, and a battery cooling system in an engine room are complicated.

As a related document, there is Korean Patent Application Laid-Open No. 2019-0068125 (published on June 18, 2019).

### DISCLOSURE

### Technical Problem

The present invention has been made in an effort to solve the above-mentioned problem, and an object of the present invention is to provide an integrated cooling module in which heat exchange components are integrated into a single module by installing a heat exchanger and a valve in a central refrigerant manifold, and the valve is disposed opposite to the heat exchanger, thereby improving packaging efficiency and refrigerant flow characteristics.

### Technical Solution

An integrated cooling module according to one example of the present invention may include: a refrigerant manifold having therein a refrigerant flow path so that a refrigerant flows through the refrigerant flow path; heat exchangers connected to the refrigerant flow path and configured to perform heat exchange with the refrigerant; and multi-way valves connected to the refrigerant flow path and configured to adjust a flow of the refrigerant, in which the heat exchanger is installed on one surface of the refrigerant manifold, and in which the multi-way valve is installed on the other surface of the refrigerant manifold opposite to one surface.

The heat exchangers may include a water-cooled condenser and a chiller, and the multi-way valves may include a first multi-way valve connected to the water-cooled condenser, and a second multi-way valve connected to the chiller.

The water-cooled condenser and the chiller may be mounted on one surface of the refrigerant manifold and disposed in parallel with each other, the first multi-way valve and the second multi-way valve may be mounted on the other surface of the refrigerant manifold, the first multi-way valve may be positioned opposite to the water-cooled condenser, and the second multi-way valve may be positioned opposite to the chiller.

The first multi-way valve may be positioned on a straight line of a center of a mounting surface of the water-cooled condenser in a mounting direction of the water-cooled condenser, and the second multi-way valve may be positioned on a straight line of a center of a mounting surface of the chiller in a mounting direction of the chiller.

The water-cooled condenser may be disposed above the chiller in a gravitational direction, and the water-cooled condenser and the chiller may be disposed horizontally in a longitudinal direction.

The water-cooled condenser and the chiller may have a refrigerant inlet port, a refrigerant outlet port, a coolant inlet port, and a coolant outlet port, the refrigerant inlet port may be disposed above the refrigerant outlet port in a gravitational direction, and the coolant inlet port may be disposed below the refrigerant outlet port in the gravitational direction.

The water-cooled condenser and the chiller may be disposed inside an outer periphery line of the refrigerant manifold.

The water-cooled condenser and the chiller may each be a plate-type heat exchanger formed by stacking a plurality of plates, a first coolant and the refrigerant may exchange heat with each other in the water-cooled condenser, and a second coolant and the refrigerant may exchange heat with each other in the chiller.

The first multi-way valve may be a three-way valve that is a switching valve, and the second multi-way valve may be a three-way valve that is an expansion valve.

The multi-way valves may further include a third multi-way valve and a fourth multi-way valve.

The third multi-way valve and the fourth multi-way valve may be mounted on the other surface of the refrigerant manifold and disposed above the water-cooled condenser and the chiller in a gravitational direction.

The third multi-way valve may be a three-way valve that is a switching valve, and the fourth multi-way valve may be a two-way valve that is an expansion valve.

The integrated cooling module may further include: a PT sensor installed to be connected to the refrigerant flow path and configured to measure pressure and temperature of the refrigerant, in which the PT sensor is mounted at any one side of the refrigerant manifold.

The refrigerant manifold may be configured in a plate-like shape and disposed in parallel with a gravitational direction.

The refrigerant manifold may include: a first inlet port through which the refrigerant is introduced from a first refrigerant circuit; a first outlet port through which the refrigerant is discharged to the first refrigerant circuit; and a second outlet port through which the refrigerant is discharged to a second refrigerant circuit, the first inlet port and the first outlet port may be disposed at one side of the refrigerant manifold, and the second outlet port may be disposed at the other side of the refrigerant manifold opposite to one side.

The refrigerant manifold may have a structure in which at least two plates are stacked and the refrigerant flow path is formed between the plates, the refrigerant manifold may include: a valve housing configured to accommodate the multi-way valve; a heat exchanger mounting portion on which the heat exchanger is mounted; pipe coupling portions to which various types of pipes are coupled; and sensor fixing portions configured to fix various types of sensors, and the refrigerant flow path may be configured to fluidly connect the valve housing, the heat exchanger mounting portion, the pipe coupling portion, and the sensor fixing portion.

### Advantageous Effects

According to the present invention, the heat exchange components are integrated into a single module by installing the heat exchanger and the valve in the central refrigerant manifold, and the valve is disposed opposite to the heat exchanger, thereby improving packaging efficiency and refrigerant flow characteristics.

### DESCRIPTION OF DRAWINGS

FIG. 1 is a perspective view of an integrated cooling module according to one example of the present invention.

FIG. 2 is an exploded perspective view in FIG. 1.

FIG. 3 is a front view of FIG. 1.

FIG. 4 is a rear view of FIG. 1.

FIG. 5 is a left side view of FIG. 1.

FIG. 6 is a right side view in FIG. 1.

FIG. 7 is a bottom plan view of FIG. 1.

FIG. 8 is a view for explaining an arrangement relationship between a heat exchanger and a multi-way valve.

FIG. 9 is a view illustrating a water-cooled condenser and a chiller.

FIG. 10 is a front perspective view of a refrigerant manifold.

FIG. 11 is an exploded view of FIG. 10.

FIG. 12 is a rear perspective view of the refrigerant manifold.

FIG. 13 is an exploded view of FIG. 12.

FIG. 14 is a view illustrating a flow of a refrigerant according to the example of the present invention.

FIG. 15 is a view illustrating a flow of a coolant according to the example of the present invention.

### Description of Reference Numerals

10: Integrated cooling module
100: Refrigerant manifold
101: Center plate
102: Front plate
103: Rear plate
110: Valve housing
120: Heat exchanger mounting portion
130: Pipe coupling portion
140: Sensor fixing portion
200: Heat exchanger
201: Water-cooled condenser
202: Chiller
300: Multi-way valve
301, 302, 303, 304: First, second, third, and fourth multi-way valves
400: PT sensor

### MODE FOR INVENTION

Hereinafter, the present invention will be described with reference to the accompanying drawings.

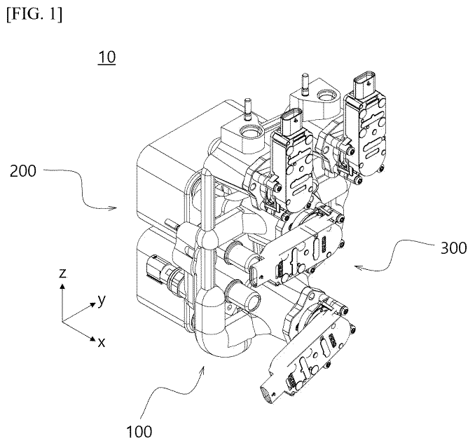

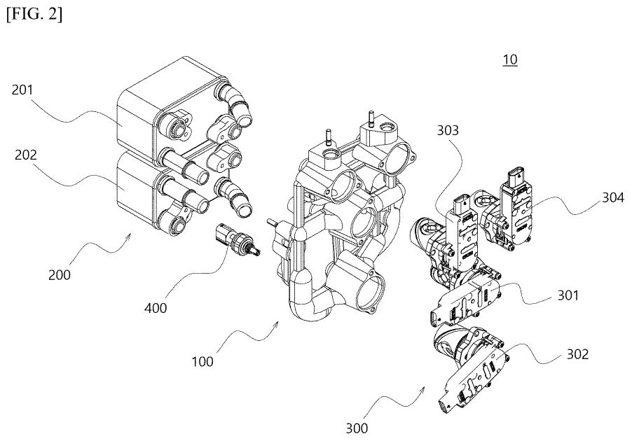

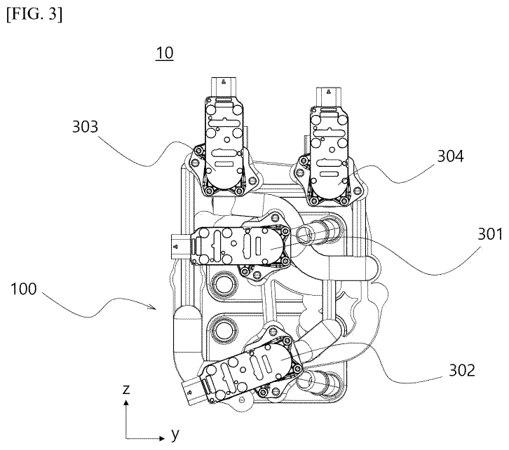

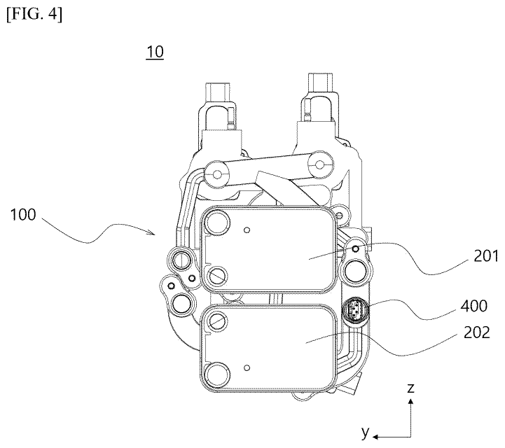

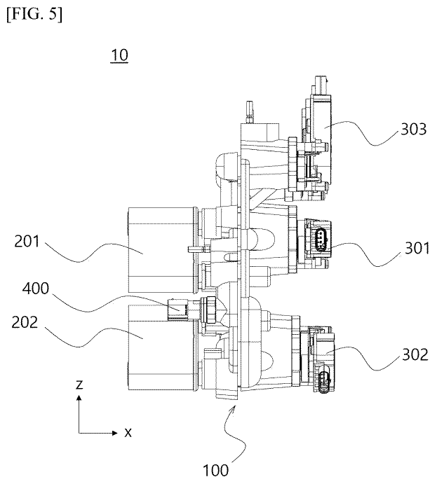

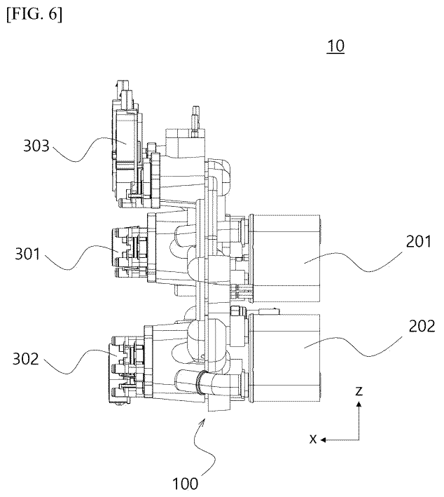

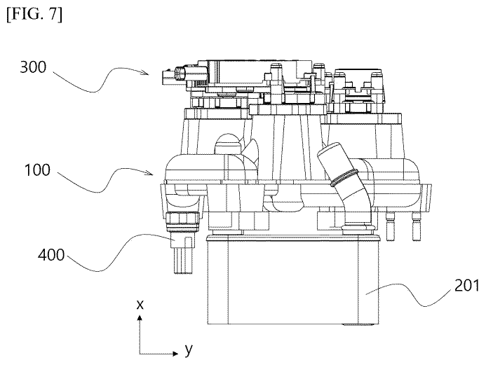

FIG. 1 is a perspective view of an integrated cooling module according to one example of the present invention, FIG. 2 is an exploded perspective view in FIG. 1, FIG. 3 is a front view of FIG. 1, FIG. 4 is a rear view of FIG. 1, FIG. 5 is a left side view of FIG. 1, FIG. 6 is a right side view in FIG. 1, and FIG. 7 is a bottom plan view of FIG. 1.

As illustrated, an integrated cooling module 10 of the present invention may broadly include a refrigerant manifold 100, a heat exchanger 200, and a multi-way valve 300 and further include a PT sensor 400.

More specifically, the refrigerant manifold 100 may be disposed at a center of the integrated cooling module 10, the heat exchanger 200 may be installed on one surface of the refrigerant manifold 100, the multi-way valve 300 may be installed on the other surface of the refrigerant manifold 100 opposite to one surface, and the PT sensor 400 may be provided as one or more PT sensors 400 installed at any one side of the refrigerant manifold 100.

A refrigerant flow path C is formed in the refrigerant manifold 100, and a refrigerant flows in the refrigerant flow path C. The refrigerant manifold 100 provides a mounting space in which various types of heat exchange components, i.e., the heat exchanger 200, the multi-way valve 300, and the PT sensor 400 may be mounted.

As illustrated in the drawings, the refrigerant manifold 100 may be configured in a plate-like shape, disposed in parallel with a gravitational direction, and installed to be perpendicular to a bottom surface. Therefore, based on the drawings, the heat exchanger 200 may be installed on a rear surface of the refrigerant manifold 100, and the multi-way valve 300 may be installed on a front surface of the refrigerant manifold 100 opposite to the rear surface of the refrigerant manifold 100. That is, one surface of the refrigerant manifold may correspond to the rear surface, and the other surface of the refrigerant manifold may correspond to the front surface. The heat exchanger 200 and the multi-way valve 300 may be mounted in a horizontal direction toward the refrigerant manifold disposed to be perpendicular to the bottom surface.

The heat exchanger 200 is a device configured to perform heat exchange with the refrigerant, the multi-way valve 300 is a device configured to adjust a flow of the refrigerant, i.e., a flow of the refrigerant or a transfer direction of the refrigerant, and the PT sensor 400 is a device configured to measure pressure and temperature of the refrigerant. The heat exchanger 200, the multi-way valve 300, and the PT sensor 400 may be mounted on the refrigerant manifold 100 and installed to be connected to the refrigerant flow path C of the refrigerant manifold. In the present invention, the configuration in which one component is connected to the refrigerant flow path means that the corresponding component and the refrigerant flow path are fluidly connected to or communicate with each other. The configuration in which two components are connected means that the corresponding two components are fluidly connected to or communicate with each other. These configurations may be implemented such that the refrigerant flows by means of the refrigerant flow path.

With the above-mentioned configuration, a flow of the refrigerant between various types of components may be intensively configured based on the refrigerant manifold. This may improve packaging efficiency of a vehicle heat exchange system while simplifying the structure, reducing the number of components and the number of assembling processes, and reducing the weight in comparison with the related art in which a connection pipe is required to allow a refrigerant to flow between the heat exchange components.

In addition, in the related art, because various types of components are spaced apart from one another and connected by pipes, a flow distance of a refrigerant is unnecessarily increased when a heat pump system switches between a cooling mode and a heating mode, which causes a problem of a deterioration in performance of the system. In contrast, according to the present invention, various types of components may be integrated into a module, thereby solving the problem.

With reference to FIGS. 1 to 7, the heat exchanger 200 includes a water-cooled condenser 201 and a chiller 202, and the multi-way valve 300 includes a first multi-way valve 301 connected to the water-cooled condenser 201, and a second multi-way valve 302 connected to the chiller 202.

The water-cooled condenser 201 may be a heat exchanger configured to condense a gaseous refrigerant into a liquid refrigerant, and the chiller 202 may be a heat exchanger configured to remove heat from the liquid refrigerant. The water-cooled condenser 201 and the chiller 202 may each be configured as a plate-type heat exchanger formed by stacking a plurality of plates. The water-cooled condenser 201 and the chiller 202 may be configured to be identical in size and shape to each other.

A first coolant and the refrigerant may exchange heat with each other in the water-cooled condenser 201, and a second coolant and the refrigerant may exchange heat with each other in the chiller 202. More specifically, the first coolant may be a coolant flowing along a first coolant circuit passing through a radiator, and the second coolant may be a coolant flowing along a second coolant circuit passing through a battery cooler. The first coolant may be introduced into the water-cooled condenser from the radiator, exchange heat with the refrigerant in the water-cooled condenser, and then be discharged back to the radiator. The second coolant may be introduced into the chiller from the battery cooler, exchange heat with the refrigerant in the chiller, and then be discharged back to the battery cooler.

The water-cooled condenser 201 and the chiller 202 are mounted on one surface, i.e., the rear surface of the refrigerant manifold 100 and disposed in parallel. The first multi-way valve 301 and the second multi-way valve 302 are mounted on the other surface, i.e., the front surface of the refrigerant manifold 100.

In this case, in consideration of the flow characteristics of the refrigerant, the water-cooled condenser 201 may be disposed above the chiller 202 in the gravitational direction, and the water-cooled condenser 201 and the chiller 202 may be disposed horizontally in a longitudinal direction (y direction in the drawings).

Further, in order to efficiently dispose the valves, the first multi-way valve 301 may be disposed opposite to the water-cooled condenser 201, and the second multi-way valve 302 may be positioned opposite to the chiller 202.

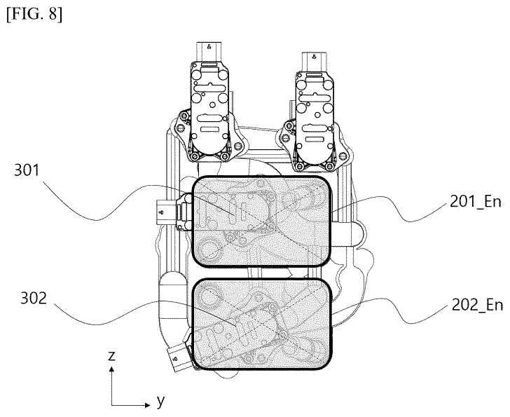

FIG. 8 is a view for explaining an arrangement relationship between the heat exchanger and the multi-way valve. As illustrated, the first multi-way valve 301 may be positioned opposite to a mounting surface of the water-cooled condenser 201 (i.e., a top plate of the water-cooled condenser) mounted on the refrigerant manifold 100, and the second multi-way valve 302 may be positioned opposite to a mounting surface of the chiller 202 (i.e., a top plate of the chiller) mounted on the refrigerant manifold 100. In other words, the first multi-way valve 301 may be disposed inside an envelope 201_En of the water-cooled condenser 201, and the second multi-way valve 302 may be disposed inside an envelope 202_En of the chiller 202. This is designed in consideration of the directionality of the refrigerant flow. It is possible to effectively cope with the increase in packaging and weight caused by unnecessary twisting of the flow path by arranging the valve that controls the flow of the refrigerant to be opposite to the heat exchanger that determines the characteristics of the refrigerant.

More specifically, the first multi-way valve 301 (or a valve housing configured to accommodate the first multi-way valve as described below) may be positioned on the mounting surface of the water-cooled condenser 201 or a straight line of a center of the envelope 201_En of the water-cooled condenser in a horizontal direction (x direction in the drawings), which is a mounting direction of the water-cooled condenser 201, and the second multi-way valve 302 (or a valve housing configured to accommodate the second multi-way valve as described below) may be positioned on the mounting surface of the chiller 202 or a straight line of a center of the envelope 202_En of the chiller in the horizontal direction (x direction in the drawings), which is a mounting direction of the chiller 202. The mounting surface or the envelope may each have an approximately quadrangular shape, and a center of each of the mounting surface or the envelope may correspond to diagonal intersection point of the corresponding quadrangular shape. Such a specific arrangement may help further reduce the packaging and weight of the module.

With reference to FIG. 8, as illustrated, the water-cooled condenser 201 and the chiller 202 may be disposed inside an outer periphery line of the refrigerant manifold 100. That is, as described above, the water-cooled condenser 201 and the chiller 202 may be configured to be identical in size and shape to each other. In this case, a length of each of the water-cooled condenser 201 and the chiller 202 in the longitudinal direction (y direction in the drawings) may be smaller than a width of the refrigerant manifold 100 (a length in the y direction in the drawings), and a sum of lengths of the water-cooled condenser 201 and the chiller 202 in a height direction (z direction in the drawings) may be smaller than a height of the refrigerant manifold 100 (a length in the z direction in the drawings). As described above, the water-cooled condenser and the chiller may be limited to the inside of the layout of the refrigerant manifold, thereby improving the packaging efficiency of the entire module.

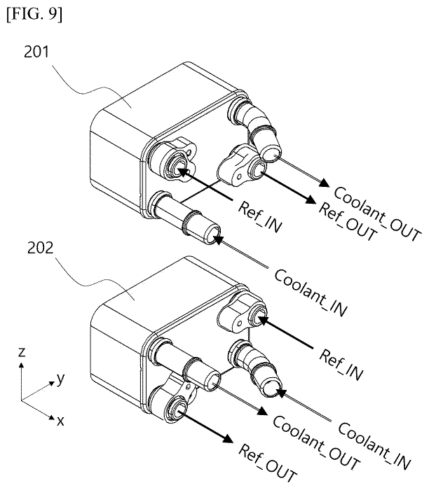

FIG. 9 is a view illustrating the water-cooled condenser and the chiller. As illustrated, the water-cooled condenser 201 and the chiller 202 may have a refrigerant inlet port Ref_IN through which the refrigerant is introduced, a refrigerant outlet port Ref_OUT through which the refrigerant is discharged, a coolant inlet port Coolant_IN through which the coolant is introduced, and a coolant outlet port Coolant_Out through which the coolant is discharged. In this case, the refrigerant inlet port Ref_IN may be disposed above the refrigerant outlet port Ref_OUT in the gravitational direction, and the coolant inlet port Coolant_IN may be disposed below the refrigerant outlet port Coolant_Out in the gravitational direction. This is designed in consideration of the characteristics of the refrigerant and the coolant. With the above-mentioned configuration, it is possible to prevent a deterioration in flow of the refrigerant in the heat exchanger and prevent the occurrence of bubbles of the coolant.

With reference back to FIGS. 1 to 7, the multi-way valve 300 further includes third and fourth multi-way valves 303 and 304 in addition to the first and second multi-way valves 301 and 302. The third multi-way valve 303 and the fourth multi-way valve 304 may be connected to each other. A more specific connection relationship between the components will be described. Further, the third multi-way valve 303 and the fourth multi-way valve 304 are mounted on the other surface, i.e., the front surface of the refrigerant manifold 100.

In this case, the third multi-way valve 303 and the fourth multi-way valve 304 may be disposed above the water-cooled condenser 201 and the chiller 202 in the gravitational direction. That is, as illustrated in the third and fourth multi-way valves 303 and 304 may be disposed to be spaced apart from one another in a leftward/rightward direction (y direction in the drawings) and disposed above the water-cooled condenser 201 disposed above the chiller 202 in the gravitational direction. This determines the flow characteristics of the refrigerant based on the functions of the third and fourth multi-way valves or the flow of the refrigerant adjusted by the corresponding multi-way valves. The third and fourth multi-way valves may be disposed at an uppermost end of the module, thereby improving the flow performance of the refrigerant in the module and the heat exchange performance of the refrigerant.

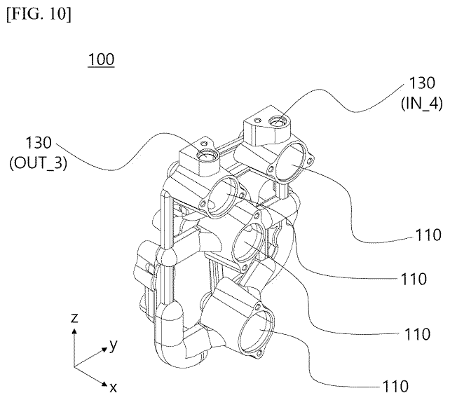

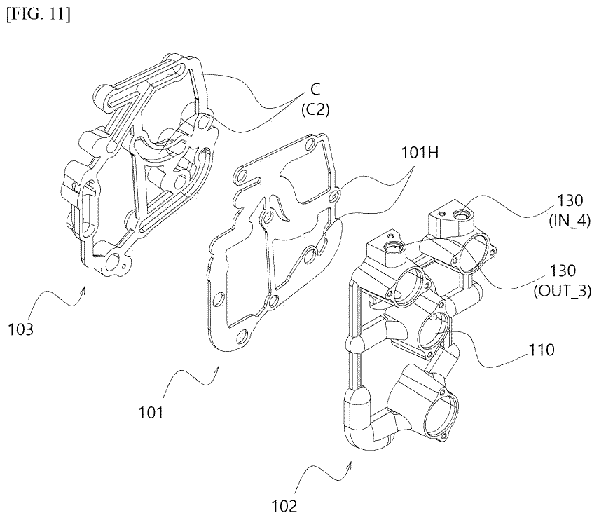

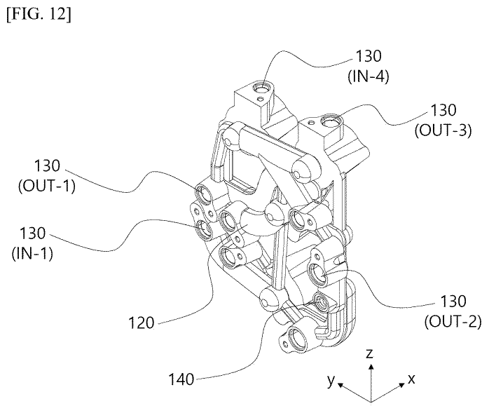

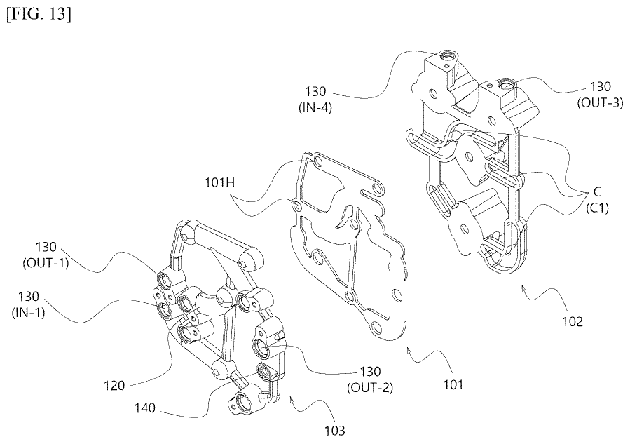

FIG. 10 is a front perspective view of a refrigerant manifold, FIG. 11 is an exploded view of FIG. 10, FIG. 12 is a rear perspective view of the refrigerant manifold, and FIG. 13 is an exploded view of FIG. 12. As illustrated, the refrigerant manifold 100 has a structure in which at least two or more plates are stacked, and the refrigerant flow path C is formed between the plates.

More specifically, the refrigerant manifold 100 may have a structure in which a front plate 102 and a rear plate 103 are respectively coupled to front and rear sides of a center plate 101. Two opposite surfaces of the center plate 101 are configured flat. The front plate 102 and the rear plate 103 may each have a shape in which a line structure protrudes toward a surface opposite to a surface adjoining the center plate 101, and a groove is formed inside the line structure. The front plate 102 and the rear plate 103 may be coupled to the center plate 101, and the refrigerant flow path C may be formed therebetween. The center plate 101 may have holes 101H. Therefore, the refrigerant flow path C1, which is formed at a front side between the front plate 102 and the center plate 101, and the refrigerant flow path C2, which is formed at a rear side between the rear plate 103 and the center plate 101, may be connected to each other. The front plate 102, the center plate 101, and the rear plate 103 may be fixed to be in surface contact with one another and then integrated by being coupled by brazing.

Further, the refrigerant manifold 100 may include a valve housing 110 configured to accommodate the multi-way valve 300, a heat exchanger mounting portion 120 on which the heat exchanger 200 is mounted, pipe coupling portions 130 to which various types of pipes are coupled, and sensor fixing portions 140 configured to fix various types of sensors, and these components may be connected to one another through the refrigerant flow path C. For example, the valve housing 110 may be integrated with the front plate 102, and the heat exchanger mounting portion 120 may be integrated with the rear plate 103. The pipe coupling portions 130 may be configured as inlets or outlets through which the refrigerant is introduced or discharged, and the pipe coupling portions 130 may be integrally on a front or rear plate 102 or 103 and coupled to external pipes. The sensor fixing portions 140 may be integrated with the front or the rear plate 103, and various types of sensors, such as the PT sensor 400, may be fixed to the sensor fixing portions 140.

With reference back to FIG. 12, as illustrated, the refrigerant manifold 100 may have a first inlet port IN-1, a first outlet port OUT-1, and a second outlet port OUT-2. The refrigerant may be introduced into the refrigerant manifold 100 from an external first refrigerant circuit through the first inlet port IN-1, the refrigerant may be discharged to the first refrigerant circuit from the refrigerant manifold 100 through the first outlet port OUT-1, and the refrigerant may be discharged to an external second refrigerant circuit from the refrigerant manifold 100 through the second outlet port OUT-2. In addition, the refrigerant manifold 100 may further have a third outlet port OUT-3 and a fourth inlet port IN-4. The coolant may be discharged to an external third refrigerant circuit from the refrigerant manifold 100 through the third outlet port OUT-3, and the refrigerant may be introduced into the refrigerant manifold 100 from an external fourth refrigerant circuit through the fourth inlet port IN-4. The first inlet port IN-1, the first outlet port OUT-1, the second outlet port OUT-2, a third inlet port IN-3, and a fourth outlet port OUT-4 may respectively correspond to the pipe coupling portions 130.

The first refrigerant circuit may be a refrigerant circuit connected to an external condenser, the second refrigerant circuit may be a refrigerant circuit connected to an external accumulator, the third refrigerant circuit may be a refrigerant circuit connected to an external evaporator, and the fourth refrigerant circuit may be a refrigerant circuit connected to an external indoor unit. The first to fourth refrigerant circuits may be configured as circuits provided independently of one another or configured as circuits at least partially connected to one another.

In this case, as illustrated, the first inlet port IN-1 and the first outlet port OUT-1 may be disposed at one side of the refrigerant manifold 100, e.g., the left side in the drawings, the second outlet port OUT-2 may be disposed at the other side of the refrigerant manifold 100, e.g., the right side in the drawings, and the third outlet port OUT-3 and the fourth inlet port IN-4 may be disposed at the further other side of the refrigerant manifold 100, e.g., the upper side in the drawings. As described above, the refrigerant inlet or outlets, which pass through different refrigerant circuits, may be spaced apart from one another, and the refrigerant inlet or outlets, which pass through the same refrigerant circuits, may be disposed adjacent to one another, thereby concisely configuring an external pipe connected to the module, reducing the length of the pipe, simplifying the layout of the entire system, and improving the connectivity between the module and the system.

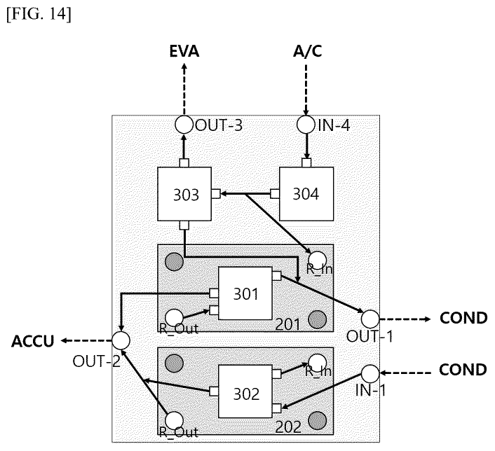

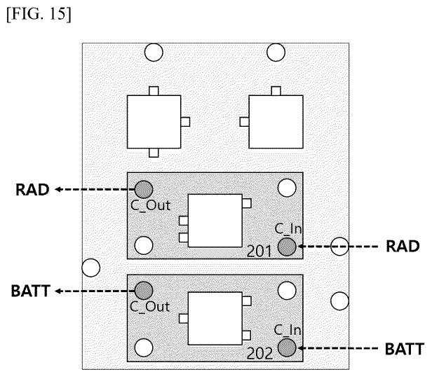

Hereinafter, a specific connection relationship between the components according to the embodiment of the present invention will be described. FIG. 14 is a view illustrating a flow of the refrigerant according to the example of the present invention, and FIG. 15 is a view illustrating a flow of the coolant according to the example of the present invention.

With reference to FIG. 14, the first multi-way valve 301 may be configured as a three-way valve, the second multi-way valve 302 may be configured as a three-way valve, the third multi-way valve 303 may be configured as a three-way valve, and the fourth multi-way valve 304 may be configured as a two-way valve. In this case, the first multi-way valve 301 and the third multi-way valve 303 may each be configured as a switching valve, and the second multi-way valve 302 and the fourth multi-way valve 304 may each be configured as an expansion valve. Further, all the first to the fourth multi-way valves 304 may be configured as electromagnetic valves.

FIG. 14 illustrates the integrated cooling module when viewed from the front side. In the drawings, a small quadrangle of each of the valves refers to a way of each of the valves. As illustrated, one side of the first multi-way valve 301 is connected to a refrigerant outlet port R_Out of the water-cooled condenser 201, the other side of the first multi-way valve 301 is connected to the first outlet port OUT-1, and the further other side of the first multi-way valve 301 is connected to the second outlet port OUT-2. One side of the second multi-way valve 302 is connected to a refrigerant inlet port R_In of the chiller 202, the other side of the second multi-way valve 302 is connected to the first inlet port IN-1, and the further other side of the second multi-way valve 302 is connected to the flow path configured to connect the second outlet port OUT-2 and the refrigerant outlet port R_Out of the chiller 202. One side of the third multi-way valve 303 is connected to the third outlet port OUT-3, the other side of the third multi-way valve 303 is connected to the second multi-way valve 302, and the further other side of the third multi-way valve 303 is connected to the flow path configured to connect the first multi-way valve 301 and the first outlet port OUT-1. One side of the fourth multi-way valve 304 is connected to the fourth inlet port IN-4, and the other side of the fourth multi-way valve 304 is connected to the third multi-way valve 303. The flow path configured to connect the third multi-way valve 303 and the fourth multi-way valve 304 is connected to the refrigerant inlet port R_In of the water-cooled condenser 201.

With reference to FIG. 15, the water-cooled condenser 201 is connected to the external radiator such that the first coolant passing through the radiator circulates through the water-cooled condenser 201 and the radiator, and the chiller 202 is connected to the external battery cooler so that the second coolant passing through the battery cooler circulates through the chiller 202 and the battery cooler.

The flow of the refrigerant will be described below with reference to FIGS. 14 and 15.

First, the refrigerant is introduced into the module from the external condenser through the first refrigerant inlet port IN-1. The introduced refrigerant moves to the second multi-way valve 302, a part of the moved refrigerant is introduced into the chiller 202, and the remaining refrigerant moves toward the second refrigerant outlet port OUT-2. The refrigerant introduced into the chiller 202 moves toward the second refrigerant outlet port OUT-2 after exchanging heat with the second coolant. The refrigerant moved to the second refrigerant inlet port R_In moves to an external accumulator ACCU through the second outlet port OUT-2. The first multi-way valve 301 may be an electromagnetic expansion valve, and the refrigerant may expand in the first multi-way valve 301.

Next, the refrigerant is introduced into the module through an external indoor unit A/C through the fourth refrigerant inlet port IN-4, and the introduced refrigerant moves to the third multi-way valve 303 or the water-cooled condenser 201 in accordance with the cooling or heating mode. In case that the refrigerant moves to the third multi-way valve 303, the refrigerant is divided into the first refrigerant outlet port OUT-1 and the third refrigerant outlet port OUT-3 and moves to an external evaporator EVA and a condenser COND. In case that the refrigerant moves to the water-cooled condenser 201, the refrigerant is introduced into the water-cooled condenser 201, the refrigerant moves to the first multi-way valve 301 after exchanging heat with the first coolant, and the refrigerant moved to the first multi-way valve 301 is divided into the second refrigerant outlet port OUT-2 and the first refrigerant outlet port OUT-1 and moves to the external accumulator ACCU and the condenser COND. The fourth multi-way valve 304 may be an electromagnetic expansion valve. The fourth multi-way valve 304 may perform only a switching operation in the cooling mode and perform an expansion function in the heating mode, such that the refrigerant may expand in the fourth multi-way valve 304. The third multi-way valve 303 may correspond to a dehumidification function, and the fourth multi-way valve 304 may correspond to a heat pump function.

As described above, the integrated cooling module of the present invention includes one two-way valve and three three-way valves, and the two valves of these valves are configured as expansion valves, thereby efficiently integrating the refrigerant-relevant parts of the vehicle heat exchange system into a single module.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

1. An integrated cooling module comprising:
a refrigerant manifold having therein a refrigerant flow path so that a refrigerant flows through the refrigerant flow path;
heat exchangers connected to the refrigerant flow path and configured to perform heat exchange with the refrigerant; and
multi-way valves connected to the refrigerant flow path and configured to adjust a flow of the refrigerant,
wherein the heat exchanger is installed on one surface of the refrigerant manifold, and
wherein the multi-way valve is installed on the other surface of the refrigerant manifold opposite to one surface.

2. The integrated cooling module of claim 1, wherein the heat exchangers comprise a water-cooled condenser and a chiller, and the multi-way valves comprise a first multi-way valve connected to the water-cooled condenser, and a second multi-way valve connected to the chiller.

3. The integrated cooling module of claim 2, wherein the water-cooled condenser and the chiller are mounted on one surface of the refrigerant manifold and disposed in parallel with each other,
wherein the first multi-way valve and the second multi-way valve are mounted on the other surface of the refrigerant manifold,
wherein the first multi-way valve is positioned opposite to the water-cooled condenser, and
wherein the second multi-way valve is positioned opposite to the chiller.

4. The integrated cooling module of claim 3, wherein the first multi-way valve is positioned on a straight line of a center of a mounting surface of the water-cooled condenser in a mounting direction of the water-cooled condenser, and
wherein the second multi-way valve is positioned on a straight line of a center of a mounting surface of the chiller in a mounting direction of the chiller.

5. The integrated cooling module of claim 3, wherein the water-cooled condenser is disposed above the chiller in a gravitational direction, and the water-cooled condenser and the chiller are disposed horizontally in a longitudinal direction.

6. The integrated cooling module of claim 3, wherein the water-cooled condenser and the chiller have a refrigerant inlet port, a refrigerant outlet port, a coolant inlet port, and a coolant outlet port,
wherein the refrigerant inlet port is disposed above the refrigerant outlet port in a gravitational direction, and
wherein the coolant inlet port is disposed below the refrigerant outlet port in the gravitational direction.

7. The integrated cooling module of claim 3, wherein the water-cooled condenser and the chiller are disposed inside an outer periphery line of the refrigerant manifold.

8. The integrated cooling module of claim 2, wherein the water-cooled condenser and the chiller are each a plate-type heat exchanger formed by stacking a plurality of plates,
wherein a first coolant and the refrigerant exchange heat with each other in the water-cooled condenser, and
wherein a second coolant and the refrigerant exchange heat with each other in the chiller.

9. The integrated cooling module of claim 2, wherein the first multi-way valve is a three-way valve that is a switching valve, and the second multi-way valve is a three-way valve that is an expansion valve.

10. The integrated cooling module of claim 2, wherein the multi-way valves further comprise a third multi-way valve and a fourth multi-way valve.

11. The integrated cooling module of claim 10, wherein the third multi-way valve and the fourth multi-way valve are mounted on the other surface of the refrigerant manifold and disposed above the water-cooled condenser and the chiller in a gravitational direction.

12. The integrated cooling module of claim 11, wherein the third multi-way valve is a three-way valve that is a switching valve, and the fourth multi-way valve is a two-way valve that is an expansion valve.

13. The integrated cooling module of claim 1, further comprising:
a PT sensor installed to be connected to the refrigerant flow path and configured to measure pressure and temperature of the refrigerant,
wherein the PT sensor is mounted at any one side of the refrigerant manifold.

14. The integrated cooling module of claim 1, wherein the refrigerant manifold is configured in a plate-like shape and disposed in parallel with a gravitational direction.

15. The integrated cooling module of claim 1, wherein the refrigerant manifold comprises:
a first inlet port through which the refrigerant is introduced from a first refrigerant circuit;
a first outlet port through which the refrigerant is discharged to the first refrigerant circuit; and
a second outlet port through which the refrigerant is discharged to a second refrigerant circuit,
wherein the first inlet port and the first outlet port are disposed at one side of the refrigerant manifold, and
wherein the second outlet port is disposed at the other side of the refrigerant manifold opposite to one side.

16. The integrated cooling module of claim 1, wherein the refrigerant manifold has a structure in which at least two plates are stacked and the refrigerant flow path is formed between the plates,
wherein the refrigerant manifold comprises:
a valve housing configured to accommodate the multi-way valve;
a heat exchanger mounting portion on which the heat exchanger is mounted;
pipe coupling portions to which various types of pipes are coupled; and
sensor fixing portions configured to fix various types of sensors, and
wherein the refrigerant flow path is configured to fluidly connect the valve housing, the heat exchanger mounting portion, the pipe coupling portion, and the sensor fixing portion.
